(19) United States
(12) Patent Application Publication
(10) Pub. No.: US 2012/0032862 A1
(43) Pub. Date: Feb. 9, 2012

(54) ANTENNA ARRANGEMENT, DIELECTRIC SUBSTRATE, PCB & DEVICE

(75) Inventor: Zhinong Ying, Lund (SE)

(73) Assignee: SONY ERICSSON MOBILE COMMUNICATIONS AB, Lund (SE)

(21) Appl. No.: 13/177,617

(22) Filed: Jul. 7, 2011

Related U.S. Application Data
(60) Provisional application No. 61/371,959, filed on Aug. 9, 2010.

(30) Foreign Application Priority Data
Aug. 9, 2010 (EP) 10172270.0
Mar. 8, 2011 (EP) PCT/EP2011/053452

(51) Int. Cl. H01Q 9/04

(52) U.S. Cl. 343/749

(57) ABSTRACT

An antenna arrangement may include a ground plane, a feeding branch, a first branch and a second branch. The first branch may be longer than the second branch. The feeding branch may be capacitively coupled to the first branch. The feeding branch, the first branch, and the second branch include inductor loading and may be arranged in a single plane at a distance from the ground plane.

### TECHNICAL FIELD

The present invention concerns an antenna arrangement, a dielectric substrate and a printed circuit board (PCB), and a device comprising such an antenna arrangement, dielectric substrate or PCB.

### BACKGROUND OF THE INVENTION

A microstrip or “patch” antenna is usually fabricated by etching an antenna element pattern in a metal trace on one side of an insulating dielectric substrate and providing a continuous metal layer bonded to the opposite side of the substrate which forms a ground plane.

Portable electronic devices, such as mobile phones, typically include a patch antenna that is connected to electrically conducting tracks or contacts on a printed circuit board by soldering or welding. Manufacturers of such electronic devices are under constant pressure to reduce the physical size, weight and cost of the devices and improve their electrical performance. This low cost requirement dictates that the electronic device and its antenna should be simple and inexpensive to manufacture and assemble, and should occupy as little space as possible.

It is also desirable for manufacturers to provide an electronic device with an antenna capable of simultaneously transmitting and/or receiving signals using different wireless communication standards, such as GSM (Global System for Mobile communications), UMTS (Universal Mobile Telecommunications System) and frequencies of 700-960 MHz and 1.7-2.7 GHz, i.e. a multiband antenna. An antenna is therefore often provided with a tuning unit that matches a transceiver with a fixed impedance to a load (feed line and antenna) impedance which is unknown, complex or otherwise does not match, so that the antenna may be used to receive and/or transmit a broad range of frequencies.

An antenna's impedance may be affected by factors, such as how the electronic device containing the antenna is being held (the so-called “head and hand effect”). When users hold their head or hands near an antenna radiator, the antenna is namely detuned, causing mismatch at the intended operating frequency. If a large metallic component, such as a loudspeaker, is placed in the vicinity of an antenna, this may also degrade the performance of the antenna.

U.S. Pat. No. 6,650,294 concerns a broadband multi-resonant antenna that utilizes capacitive coupling between multiple conductive plates for compact antenna applications. The number and design of conductive plates may be set to achieve the desired bandwidth. The antenna may be designed for four resonant frequencies and may include three L shaped legs each including a micro-strip conductive plate and connection pin, with configurations approximately parallel to one another. The centre L-shaped leg may be a feed patch with a feed pin connected to a transmitter, receiver, or transceiver. The upper L-shaped leg may be a dual band main patch and ground pin. The dual band main patch may have two different branches with different lengths and areas to handle three of four desired resonant frequencies. The lower L shaped leg may be a parasitic high band patch and ground pin designed to handle one of the two higher desired resonant frequencies. A drawback with such an antenna is that the multilayer structure of the antenna is not easy to manufacture.

### SUMMARY OF THE INVENTION

An object of the invention is to provide an improved antenna arrangement that is suitable for multiband applications.

This object is achieved by an antenna arrangement comprising a ground plane, a feeding branch, a first branch and a second branch whereby the first branch is longer than the second branch. The feeding branch is capacitively coupled to the first branch to create a variable capacitance, inductance and/or impedance as a function of frequency which increases the bandwidth. The design and length of the feeding branch and the first branch may be selected to achieve the desired bandwidth and/or the number of distinct transmission frequencies for a particular application. The feeding branch, the first branch and the second branch comprise inductor loading and are arranged in a single plane at a distance from the ground plane. The inductance of the inductor loading is chosen so that a resonance frequency of the antenna arrangement corresponds to an operating frequency thereof or for size reduction, filtering and matching, and antenna efficiency improvement purposes. The inductor loading can therefore be arranged to create multiple resonances with good bandwidth. A multiband antenna arrangement may therefore be realized which may consequently increase the functionality of a device in which it is included.

Such a one-layer multiband antenna arrangement has been found to significantly improve the antenna performance, i.e. antenna efficiency and bandwidth, Total Radiated Power (TRP) and Total Isotropic Sensitivity (TIS). The antenna arrangement is of compact design and alleviates the head and hand effect even if a metallic component (RF-lossy material), such as a loudspeaker is placed in the vicinity of the antenna arrangement, since the antenna arrangement may be arranged at the bottom of a portable electronic device. Furthermore, such an antenna arrangement requires no matching or switching circuits, which leads to a reduction in manufacturing costs, time and complexity. Having said that, a matching or switching circuit may however be used with the antenna arrangement according to the present invention.

According to an embodiment of the invention the feeding branch, the first branch and/or the second branch each comprise a first conducting portion, a second conducting portion and a gap between the first and second conducting portions, whereby a plurality of inductor elements is connected in parallel across the gap. The inductor elements may comprise wire wound elements having at least one coil or chip inductor or any other kind of inductor. It should be noted that the feeding branch, the first branch and the second branch may comprise any number of such conducting portions and gaps. The accompanying claims recite a plurality of inductor elements, since a plurality of inductor elements have been found to substantially improve the performance of an antenna arrangement in a manner in which a single inductor element connected across a gap does not.

According to an embodiment of the invention the feeding branch may comprise an L-shaped portion and the first branch may be arranged to substantially follow and surround the end of the L-shaped portion of the feeding branch.

According to another embodiment of the invention the antenna arrangement may include capacitive coupling between the feed branch and the second branch.

According to a further embodiment of the invention the antenna arrangement is arranged to transmit and/or receive frequencies in one, or more, or all of the following frequency ranges: 700-800 MHz, 824-894 MHz, 880-960 MHz, 1710-1850 MHz, 1820-1990 MHz, 1920-1990 MHz, 1920-2170 MHz, 2500-2700 MHz.

According to an embodiment of the invention the antenna arrangement comprises a switching circuit, such as a pin-diode or a micro-electromechanical system (MEMS) switch so that the antenna arrangement may be tuned to more frequency bands. The first branch and/or the second branch may for example be arranged to be switched to a different inductor loading.

The present invention also concerns a dielectric substrate or printed circuit board (PCB) that comprises an antenna arrangement according to any of the embodiments of the invention.

The present invention further concerns a device that comprises an antenna arrangement, a dielectric substrate or a PCB according to any of the embodiments of the invention. The device may be a portable or non-portable electronic device, such as a telephone, media player, Personal Communications System (PCS) terminal, Personal Data Assistant (PDA), laptop computer, palmtop receiver, camera, television, radar or any appliance that includes a transducer designed to transmit and/or receive radio, television, microwave, telephone and/or radar signals. The antenna arrangement, dielectric substrate and PCB according to the present invention are however intended for use particularly, but not exclusively for high frequency radio equipment.

According to an embodiment of the invention the device is a mobile communication device. The mobile communication device may be a mobile telephone, wherein the antenna arrangement is preferably arranged at the bottom of the mobile communication device when it is in use in order to optimize the talk-position performance, including antenna efficiency, TRP, TIS, and Specific Absorption Rate (SAR), Hearing Aids Compatibility (HAC) and unavoidably, to reduce the hand effect. It is however also possible to arrange the antenna arrangement at the top of a mobile communication device.

According to an embodiment of the invention the device comprises a chassis and at least part of the antenna arrangement is arranged on part of the chassis of the device.

### BRIEF DESCRIPTION OF THE DRAWINGS

The present invention will hereinafter be further explained by means of non-limiting examples with reference to the appended figures where;

FIG. 1 shows an antenna arrangement according to an embodiment of the invention,

FIGS. 2 & 3 are graphs illustrating frequency responses for an operational antenna arrangement according to an embodiment of the invention, and

FIG. 4 shows a device according to an embodiment of the invention.

It should be noted that the drawings have not been drawn to scale and that the dimensions of certain features have been exaggerated for the sake of clarity.

### DETAILED DESCRIPTION OF EMBODIMENTS

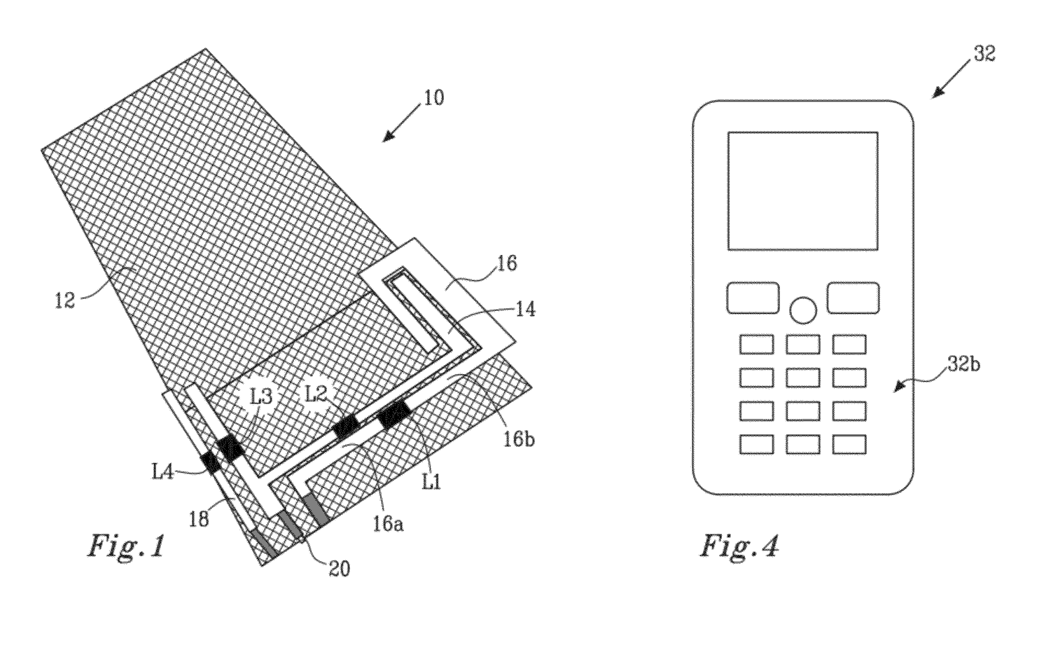

FIG. 1 shows an on-ground multiband tunable L-loading coupling-fed antenna arrangement 10 according to an embodiment of the invention. The antenna arrangement 10 comprises a ground plane 12, a feeding branch 14, a first branch 16, and a second branch 18 whereby the first branch 16 is longer than the second branch 18. The feeding branch 14, the first branch 16 and the second branch 18 are arranged in a single plane at a distance from the ground plane 12 and are arranged to provide resonant frequencies useful for radio communications. Dielectric material (constituting at least part of a dielectric substrate, PCB or part of a device chassis for example) or air may be arranged between the ground plane 12 and the plane containing the feeding branch 14, the first branch 16 and the second branch 18.

The feeding branch 14 is capacitively coupled to the first branch 16. The first branch 16 and the second branch 18 may consequently include one or more distinct areas which will be resonant at predetermined desired frequencies that have a wider bandwidth due to the capacitive coupling between the feeding branch 14 and the first branch 16.

The feeding branch 14 comprises inductor loading L1, the first branch 16 comprises inductor loading L2 and L3 and the second branch 18 comprises inductor loading L4. The first branch 16 and the second branch 18 are connected to the ground plane 12 via ground pins for example, and the feeding branch 14 is connected to a feed point 20, via a feed pin for example, the single feed point 20 being arranged to be connected to a receiver, transmitter or transceiver. The ground pins and feed pin may be arranged to extend substantially perpendicularly to the substrate, PCB or part of the device chassis that supports the antenna arrangement 10 so as to form an L-shape with the first and second branches 16 and 18 and the feeding branch 14. The branches 14, 16 and 18 of the antenna arrangement may for example comprise printed conductive traces formed on the dielectric material of the substrate, PCB, or device chassis part.

The first branch 16 comprises a first conducting portion 16a, a second conducting portion 16b and a gap between the first and second conducting portions 16a and 16b, whereby a plurality of inductor elements, constituting the inductor loading L1, is connected in parallel across the gap. The second branch 18 and the feeding branch 14 are also arranged in such a manner although the feeding branch in the illustrated embodiment comprises two gaps containing inductor loading L2 and L3. The inductor elements may comprise wire wound elements having at least one coil or chip inductor or any other kind of inductor. The conducting portions 16a, 16b may be of any form and may for example comprise a meandering conducting path.

The feeding branch 14 in the illustrated embodiment comprises an L-shaped portion and the first branch 16 is arranged to substantially follow and surround the end of the L-shaped portion of the feeding branch 14, i.e. to have portions that extend along both sides of the L-shaped portion of the feeding branch 14, around the distal end of the L-shaped portion of the feeding branch 14 and along at least part of the inner side of the L-shaped portion of the feeding branch 14 as shown in FIG. 1.

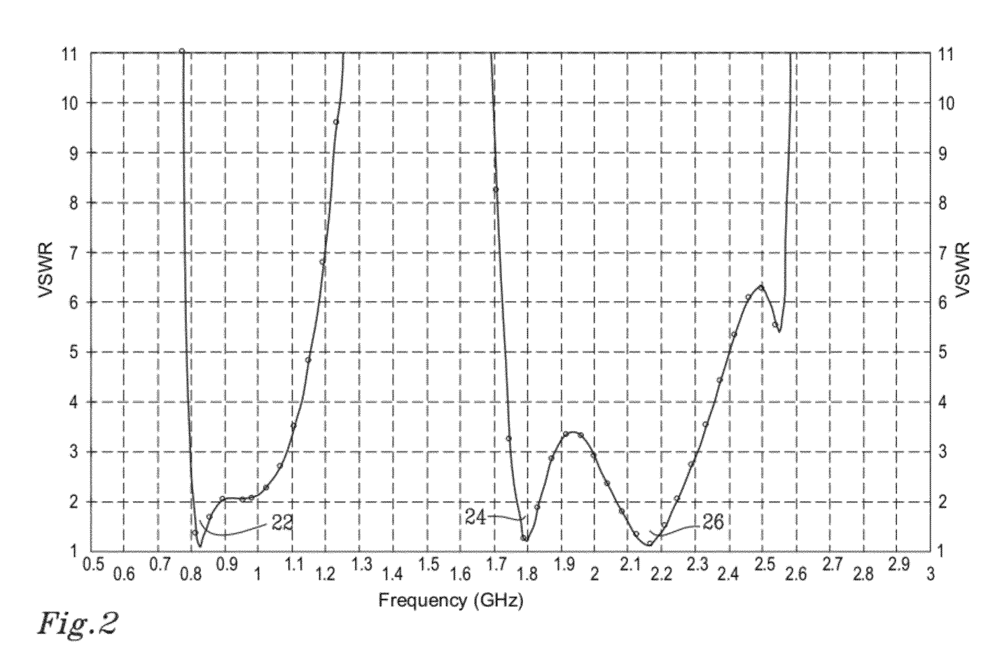

FIG. 2 shows a graph illustrating the frequency response for an operational antenna arrangement 10 according to an embodiment of the invention, such as the antenna arrangement 10 illustrated in FIG. 1. Frequency is shown on the x-axis and the voltage standing wave ratio (VSWR) is shown on the y-axis. The VSWR is a measure of how well a load is impedance-matched to a source. The value of VSWR is always expressed as a ratio with 1 in the denominator (2:1, 3:1, 10:1, etc.) It is a scalar measurement only (no angle), so although they reflect waves oppositely, a short circuit and an open circuit have the same VSWR value (infinity:1). A perfect impedance match corresponds to a VSWR 1:1, but in practice this is impossible to achieve. Impedance matching means that maximum power transfer from source to load will be obtained.

The frequency response shown in FIG. 1 has three distinct resonance bands with best performance points at 22, 24 and 26. The lowest resonant frequency is at point 22, at approximately 0.8 GHz, and corresponds to the low frequency resonance band of the first branch 16 and has a VSWR of approximately 1. The two higher resonant frequencies are at points 24 and 26, at approximately 1.8 GHz and 2.15 GHz respectively, and correspond to the high frequency resonance bands of the second branch 18 and the feeding branch 14 respectively. Such an antenna may therefore be successfully used for broadband applications, for example in a three band mobile telephone.

An antenna arrangement 10 according to the present invention may comprise a switching circuit for example to enable the antenna whose frequency response is shown in FIG. 2 to be operable in more frequency bands. For example, a switching circuit, such as a pin-diode or MEMS switch may be used to switch the inductive coupling, L1, on the first branch 16 of the antenna arrangement 10 to another inductor loading, L5 (not shown) and/or to switch the inductive coupling, L4, on the second branch 18 of the antenna arrangement 10 to another inductor loading, L6 (not shown) for example.

FIG. 3 shows the frequency response for an antenna that has five distinct resonance bands with best performance points at 22, 24, 26 (as shown in FIG. 2), 28 and 30. The lowest resonant frequencies at points 22 and 28, at approximately 0.8 GHz and 1 GHz, correspond to the low frequency resonance bands of the first branch 16. The two higher resonant frequencies at points 24 and 30, at approximately 1.8 GHz and 2.45 GHz respectively, correspond to the high frequency resonance bands of the second branch 18, and the high resonant frequency at point 26 corresponds to the high frequency resonance band of the feeding branch 14. Such an antenna arrangement may therefore be successfully used for broadband applications, for example in a five band mobile telephone. The antenna arrangement according to the present invention is preferably arranged to be used in an 8-band device.

Numerous variations for the physical structure and layout of the antenna arrangement according to the present invention are possible in order to achieve various desired broadband applications and performance. For example, the location of the branches and connector pins (ground pings and feed pin) for the antenna arrangement could be varied and still achieve a broadband multiband antenna. It is only necessary that their respective locations, sizes, shapes, and distance relative to the substrate and to one another be set so as to tune the antenna arrangement to the desired frequencies and match the antenna arrangement to a device's system impedance. Furthermore, the branches can be any shape such as, but not limited to, rectangular, triangle, circular, and they can be two dimensional or three dimensional or have a T or M shape.

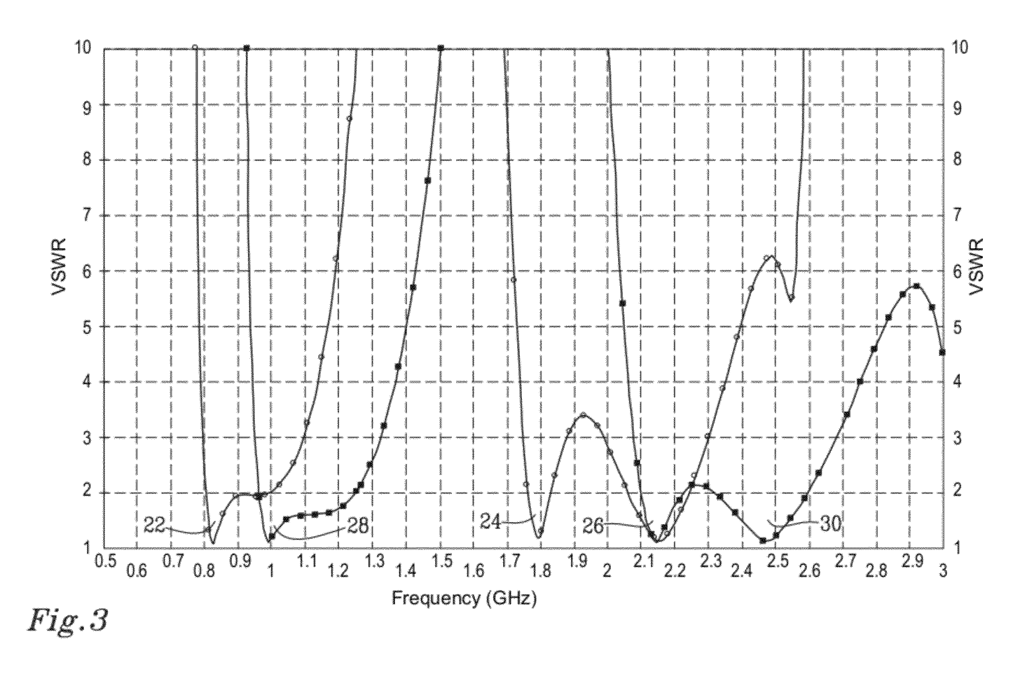

FIG. 4 shows a device 32 comprising a built-in antenna arrangement (not shown) according to the present invention. The device 32 may be arranged to transmit and/or receive frequencies in one, or more, or all of the following frequency ranges: 700-800 MHz, 824-894 MHz, 880-960 MHz, 1710-1850 MHz, 1820-1990 MHz, 1920-1990 MHz, 1920-2170 MHz, 2500-2700 MHz.

According to an embodiment of the invention the antenna arrangement 10 is arranged at the bottom 32b of the device 32 when the device is in use. At least part of the antenna arrangement 10 may be arranged on part of a chassis of the device 32.

Further modifications of the invention within the scope of the claims would be apparent to a skilled person.

What is claimed is:

1. An antenna arrangement comprising:
a ground plane;
a feeding branch; and
a first branch and a second branch, wherein the first branch is longer than the second branch,
wherein the feeding branch is capacitively coupled to the first branch, and
wherein the feeding branch, the first branch, and the second branch comprise inductor loading and are arranged in a single plane at a distance from the ground plane.

2. The antenna arrangement of claim 1,
wherein the feeding branch, the first branch, and the second branch each comprise a first conducting portion, a second conducting portion, and a gap between the first and second conducting portions,
wherein a plurality of inductor elements are connected in parallel across the gap.

3. The antenna arrangement according to claim 2, wherein one or more of the inductor elements comprise wound wire having at least one coil or a chip inductor.

4. The antenna arrangement according to claim 2, wherein the feeding branch comprises an L-shaped portion, and the first branch is arranged to substantially follow and surround the end of the L-shaped portion of the feeding branch.

5. The antenna arrangement according to claim 1, wherein the antenna arrangement is configured to transmit or receive frequencies in one or more of the following frequency ranges: 700-800 MHz, 824-894 MHz, 880-960 MHz, 1710-1850 MHz, 1820-1990 MHz, 1920-1990 MHz, 1920-2170 MHz, or 2500-2700 MHz.

6. The antenna arrangement according to claim 1, further comprising a switching circuit.

7. The antenna arrangement according to claim 1, further comprising a dielectric substrate or printed circuit board (PCB).

8. A mobile communication device comprising an antenna, the antenna comprising a ground plane, a feeding branch, a first branch, and a second branch, wherein the first branch is longer than the second branch, wherein the feeding branch is capacitively coupled to the first branch, and wherein the feeding branch, the first branch, and the second branch comprise inductor loading and are arranged in a single plane at a distance from the ground plane.

9. The mobile communication device of claim 8,
wherein the feeding branch, the first branch, and the second branch each comprise a first conducting portion, a second conducting portion, and a gap between the first and second conducting portions,
wherein a plurality of inductors are connected in parallel across the gap.

10. The mobile communication device of claim 9, wherein one or more of the inductors comprise wound wire having at least one coil or a chip inductor.

11. The mobile communication device according to claim 8, wherein the feeding branch comprises an L-shaped portion, and the first branch is arranged to substantially follow and surround the end of the L-shaped portion of the feeding branch.

12. The mobile communication device according to claim 8, wherein the antenna arrangement is configured to transmit or receive frequencies in one or more of the following frequency ranges: 700-800 MHz, 824-894 MHz, 880-960 MHz, 1710-1850 MHz, 1820-1990 MHz, 1920-1990 MHz, 1920-2170 MHz, or 2500-2700 MHz.

13. The mobile communication device according to claim 8, further comprising a switching circuit.

14. The mobile communication device according to claim 8, further comprising a dielectric substrate or printed circuit board (PCB).

15. The mobile device according to claim 8, wherein the device comprises a mobile telephone device.

16. The mobile communication device according to claim 9, wherein the antenna arrangement is arranged at the bottom of the mobile communication device when in use by a user.

17. The mobile communication device according to claim 8, further comprising:
a chassis, wherein a portion of the antenna arrangement is arranged on a portion of the chassis.

18. An antenna arrangement comprising:
a ground plane;
a feeding branch; and
a first branch and a second branch, wherein the first branch is longer than the second branch,
wherein the feeding branch is capacitively coupled to the first branch, and
wherein the feeding branch, the first branch, and the second branch comprise inductor loading and are arranged in a single plane at a distance from the ground plane,
wherein the feeding branch comprises an L-shaped portion, and the first branch is arranged to substantially follow and surround the end of the L-shaped portion of the feeding branch.
wherein a plurality of inductors are connected in parallel across the gap.

19. The antenna arrangement according to claim 18, wherein one or more of the inductors comprise wound wire having at least one coil or chip inductor or any other kind of inductor.

20. The antenna arrangement according to claim 19, wherein the antenna arrangement is configured to transmit or receive frequencies in one or more of the following frequency ranges: 700-800 MHz, 824-894 MHz, 880-960 MHz, 1710-1850 MHz, 1820-1990 MHz, 1920-1990 MHz, 1920-2170 MHz, or 2500-2700 MHz.
